(19) United States
(12) Patent Application Publication
(10) Pub. No.: US 2023/0400608 A1
(43) Pub. Date: Dec. 14, 2023

(54) MULTI-LEVEL OPTICAL DIFFUSER WITH HIGH NEAR INFRARED CLARITY

(71) Applicant: 3M INNOVATIVE PROPERTIES COMPANY, St. Paul, MN (US)

(72) Inventors: Steven H. Kong, Woodbury, MN (US); Nicholas C. Erickson, Saint Paul, MN (US); David A. Rosen, North Saint Paul, MN (US)

(21) Appl. No.: 18/033,631

(22) PCT Filed: Oct. 1, 2021
(86) PCT No.: PCT/IB2021/059054

§ 371 Date: Apr. 25, 2023

Related U.S. Application Data
(60) Provisional application No. 63/105,960, filed on Oct. 27, 2020.

(51) Int. Cl. G02B 5/02

(52) U.S. Cl. CPC G02B 5/0221

(57) ABSTRACT

An optically diffusive film includes a structured first major surface with a plurality of substantially parallel, substantially planar first surfaces arranged across the first major surface at a plurality of different first height levels. A height difference between any two of the first surfaces is S times Hmin, where S is a number within 15% of an integer and Hmin is a height difference between lowest and next-lowest first surfaces. For a substantially collimated incident light and for a first wavelength in a human-visible wavelength range, the optically diffusive film has an optical haze, Hv, and an optical clarity, Cv, and for a second wavelength in an infrared wavelength range, the optically diffusive film has an optical haze, Hi, and an optical clarity, Ci, such that the ratio Hv/Hi is greater than or equal to 1.5 and the ratio Ci/Cv is greater than or equal to 1.5.

### SUMMARY

In some aspects of the present description, an optically diffusive film is provided, the optically diffusive film including a structured first major surface with a plurality of substantially parallel, substantially planar first surfaces arranged across the first major surface at a plurality of different first height levels along a thickness direction of the optically diffusive film. A height difference between any two of the first surfaces is S times Hmin, where S is a number within 15% of an integer and Hmin is a height difference between the lowest and next-lowest first surfaces. For a substantially collimated incident light substantially normally incident on a plane of the first major surface, and for at least a first wavelength in a visible wavelength range extending from about 400 nm to about 700 nm, the optically diffusive film has an optical haze, Hv, and an optical clarity, Cv, and for at least a second wavelength in an infrared wavelength range extending from about 700 nm to about 2000 nm, the optically diffusive film has an optical haze, Hi, and an optical clarity, Ci, such that the ratio Hv/Hi is greater than or equal to about 1.2, or greater than or equal to about 1.5, or greater than or equal to about 2.0, or greater than or equal to about 5, or greater than or equal to about 10, and the ration Ci/Cv is greater than or equal to about 1.2, or greater than or equal to about 1.5, or greater than or equal to about 2.0, or greater than or equal to about 5, or greater than or equal to about 10.

In some aspects of the present description, an optically diffusive film is provided, the optically diffusive film including a structured first major surface having a plurality of substantially parallel, substantially planar first surfaces arranged across the first major surface at a plurality of at least three first height levels relative to a lowest first surface, and a plurality of substantially parallel, substantially planar second surfaces, each second surface disposed above, and within a perimeter of, a corresponding first surface at a second height level relative to the corresponding first surface, the second height level being between about 20% and about 40%, or between about 15% and about 30%, of a height difference between the lowest and next-lowest first surfaces.

### BRIEF DESCRIPTION OF THE DRAWINGS

FIG. 1 is a side view of an optically diffusive film with a plurality of first structures, in accordance with an embodiment of the present description;

FIGS. 2A and 2B depict computer models of the optically diffusive film of FIG. 1, in accordance with an embodiment of the present description;

FIG. 3 is a histogram of the various height levels of the optically diffusive film of FIG. 1, in accordance with an embodiment of the present description;

FIGS. 4A-4C provide views of an optically diffusive film with a plurality of first structures and a plurality of smaller second structures, in accordance with an embodiment of the present description;

FIGS. 5A and 5B show additional detail regarding the relationship between the first and second structures of FIG. 4A, in accordance with an embodiment of the present description;

FIG. 6 depicts a computer model of the optically diffusive film of FIG. 4A, in accordance with an embodiment of the present description;

FIG. 7 is a histogram of the various height levels of the optically diffusive film of FIG. 4A, in accordance with an embodiment of the present description;

FIG. 8 is a side view of an optically diffusive film with a plurality of first structures, each structure having at least one height step, in accordance with an embodiment of the present description;

FIGS. 9A and 9B depict computer models of the optically diffusive film of FIG. 8, in accordance with an embodiment of the present description;

FIG. 10 is a histogram of the various height levels of the optically diffusive film of FIG. 8, in accordance with an embodiment of the present description;

FIGS. 11A and 11B provide views of an optically diffusive film featuring a plurality of first structures embedded in a top optical layer, in accordance with an embodiment of the present description;

FIGS. 12A and 12B provide plots of optical haze versus wavelength and optical clarity versus wavelength, respectively, for an optically diffusive film, in accordance with an embodiment of the present description;

FIGS. 13A and 13B illustrate an optically diffusive film with a plurality of structures featuring a surface texture, in accordance with an embodiment of the present description; and

FIGS. 14A and 14B illustrate an optically diffusive film with a plurality of first structures featuring a surface texture and a plurality of second structures, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Optical diffuser films may be used in display backlights to diffuse the light from the light source, which may be a bank of light-emitting diodes (for example), to help increase the uniformity of the backlight (e.g., to scatter light from potentially bright point sources). However, standard optical diffuser films may scatter light not only in the human-visible (visible) wavelengths, but also in the near infrared wavelengths that are often used by fingerprint sensors disposed beneath the display surface, thereby distorting the image of the fingerprint ridges needed to identify a user. In these situations, an ideal optical diffuser film is one that provides sufficient diffusion in the visible wavelengths to provide the required uniformity to the display, while having sufficient optical clarity in the infrared wavelengths, at least those infrared wavelengths used by the fingerprint sensor, to read and identify a fingerprint.

According to some aspects of the present description, an optically diffusive film presents low clarity for visible wavelengths of light but remains sufficiently optically “clear” in the near infrared wavelengths. This is achieved by introducing a plurality of substantially parallel, substantially planar first surfaces onto one side of a film, and selecting varying height levels for the first surfaces such that a “band edge” is created between the visible and near infrared portions of incident light, such that clarity is relatively low to the left of the band edge and relatively high to the right of the band edge.

According to some aspects of the present description, an optically diffusive film includes a structured first major surface with a plurality of substantially parallel, substantially planar first surfaces arranged across the first major surface at a plurality of different first height levels along a thickness direction of the optically diffusive film. In some embodiments, a height difference between any two of the first surfaces is S times Hmin, where S is a number within 15% of an integer, and Hmin is a height difference between the lowest and next-lowest first surfaces. In some embodiments, the optically diffusive film may include a second major surface opposing the first major surface. In some such embodiments, the second major surface may be substantially planar. For a substantially collimated, incident light which is substantially normally incident on a plane of the first major surface, and for at least a first wavelength in a visible (i.e., human-visible) wavelength range extending from about 400 nm to about 700 nm, or from about 420 nm to about 650 nm, the optically diffusive film has an optical haze, Hv, and an optical clarity, Cv, and for at least a second wavelength in an infrared wavelength range extending from about 700 nm to about 2000 nm, or about 800 nm to about 1500 nm, the optically diffusive film has an optical haze, Hi, and an optical clarity, Ci, such that the ratio Hv/Hi is greater than or equal to about 1.2, or greater than or equal to about 1.5, or greater than or equal to about 2.0, or greater than or equal to about 5, or greater than or equal to about 10, and the ration Ci/Cv is greater than or equal to about 1.2, or greater than or equal to about 1.5, or greater than or equal to about 2.0, or greater than or equal to about 5, or greater than or equal to about 10.

For the purposes of this specification, optical haze shall be defined as a ratio of a diffuse transmission to a total transmission of the incident light, and optical clarity shall be defined as a ratio of a specular transmission to the total transmission of the incident light. For the purposes of this specification, these terms shall be defined relative to a “cone” of light defined by the full divergence angle of the substantially collimated incident light. Specular transmission is that portion of the incident light that is within the cone (i.e., within the full divergence angle of the substantially collimated incident light) and diffuse transmission is that portion of the incident light that is outside of the cone. In some embodiments, the full divergence angle of the incident light may be less than about 2 degrees, or less than about 1 degree, or less than about 0.5 degrees. Stated another way, the full divergence angle of the incident light may be substantially less than the full divergence angle of the transmitted light.

It should be noted that the concepts discussed herein may be applied to optical properties related to optical reflection as well as optical transmission. For example, the optically diffusive film as described herein may be a reflective film, where the optical reflection (i.e., the incident light reflected from structured major surface of the film) may be either specular or diffuse, as defined above. That is, for the purposes of this specification, optical haze may also be defined (in the case of optical reflection) as a ratio of diffuse reflection to the total reflection of the incident light, and optical clarity may also be defined as a ratio of specular reflection to the total reflection of the incident light. Therefore, it is possible to create a multi-level reflective film (e.g., a mirror) which, for example, has higher reflected optical haze (and lower optical clarity) in at least some of the visible wavelengths, and lower optical haze (and higher optical clarity) in at least some of the infrared wavelengths.

In some embodiments, the optically diffusive film may further include a resin having a refractive index of about 1.66 for light with a wavelength of 940 nanometers.

In some embodiments, each of the substantially parallel, substantially planar first surfaces has a plurality of sidewalls, and each of the sidewalls is substantially vertical. Stated another way, each of the substantially planar first surfaces is a top surface of a three-dimensional surface structure with substantially vertical sidewalls (e.g., the sidewalls may have a maximum angle from vertical of less than or equal to about 10 degrees). In some embodiments, the percentage of area of the structured first surface which is covered by the substantially parallel, substantially planar first surfaces is at least 80%, or at least 85%, or at least 90%, or at least 95%.

In some embodiments, the shape of the top of each of the substantially planar first surfaces may be similar to the shapes of the tops of each of the other substantially planar first surfaces. In some embodiments, the shape of at least leach one of the substantially planar first surfaces may be different than a shape of the top of at least one other substantially planar first surfaces. In some embodiments, the shape of each of the substantially planar first surfaces may be an irregular polygon. In other embodiments, the shape of each of the substantially planar first surfaces may be a regular polygon.

In some embodiments, the maximum lateral dimension of the substantially planar first surfaces may be between about 2 microns and about 15 microns. In some embodiments, the maximum lateral dimension of the substantially planar first surfaces may be between about 10 microns and about 25 microns. In some embodiments, the maximum lateral dimension of the substantially planar first surfaces may be greater than 25 microns. In some embodiments, the value of Hmin may be about 2 microns. In some embodiments, the number of discrete height levels of the substantially planar first surfaces may be four. In some embodiments, the height distribution of each of the discrete height levels may be represented by the ratio (100/N) %, where N in the number of discrete height levels. For example, when there are four discrete height levels, the percent of each of the height levels may be about (100/4)=25%. In another example with five discrete height levels, the percent distribution of each of the levels may be about (100/5)=20%. In some embodiments, the number of discrete height levels may be chosen such that the optically diffusive film exhibits high zeroth order diffraction efficiencies for the at least one wavelength in the second wavelength range. In such embodiments, for at least one wavelength in the second wavelength range, the plurality of discrete height levels may result in a phase difference between the light transmitted through the optically diffusive film and light transmitted through air that is about a multiple of 2π.

In some embodiments, the optically diffusive film may further include a planarizing layer which is disposed on the structured first major surface, such that at least a portion of the substantially planar first surfaces are embedded within the planarizing layer. In other embodiments, the optically diffusive film may include a conformal coating layer, such that at least a portion of the substantially planar first surfaces are embedded within the conformal coating layer. While a top surface of the planarizing layer would be substantially flat (planar), the top surface of the conformal coating layer would substantially conform to, and emulate, the height differences of the substantially planar first surfaces. In some embodiments, the material for either the planarizing layer or the conformal coating layer may be optically transparent, with an index of refraction different from the substantially planar first surfaces and chosen to produce the desired optical performance for the optically diffusive film.

In some embodiments, the performance of the optically diffusive film may be “tuned” or configured such that it meets specific optical requirements. This may be done by introducing additional height levels to the film. For example, in some embodiments, at least a portion of the substantially planar first surfaces may include at least one height step. In some embodiments, the height step may be substantially less than Hmin, such as less than 50%, or less than 40%, or less than 30%, or less than 20% of Hmin. In other embodiments, a plurality of smaller, secondary structures may be superimposed on, and contained within a perimeter of, at least a portion of the substantially planar first surfaces. In some embodiments, the height of each of the secondary structures may be substantially the same across the optically diffusive film. In other embodiments, the height of each of the secondary structures may vary across the optically diffusive film. In some embodiments, the plurality of secondary structures may be disposed on the second major surface of the optically diffusive film, that is, a second major surface opposite to the first major surface containing the substantially planar first surfaces. In other embodiments, the plurality of secondary structures may be disposed on a separate optical layer which is disposed adjacent to and substantially coextensive with the optically diffusive film. In those embodiments including the plurality of secondary structures, the optically diffusive film may, for at least one wavelength in the visible wavelength range, exhibit a third transmitted haze, where the third transmitted haze is greater than the first transmitted haze. In some embodiments, the height of these secondary structures may be substantially less than Hmin, such as less than 50%, or less than 40%, or less than 30%, or less than 20% of Hmin.

According to some aspects of the present description, an optically diffusive film may include a structured first major surface having a plurality of substantially parallel, substantially planar first surfaces arranged across the first major surface at a plurality of at least three first height levels relative to a lowest first surface, and a plurality of substantially parallel, substantially planar second surfaces, each second surface disposed above, and within a perimeter of, a corresponding first surface at a second height level relative to the corresponding first surface, the second height level being between about 20% and about 40%, or between about 15% and about 30%, of a height difference between the lowest and next-lowest first surfaces. In some embodiments, a height difference between any two of the first surfaces may be S times Hmin, where S a number within about 20%, or about 15%, or about 10% of an integer, and Hmin may be a height difference between lowest and next-lowest first surfaces.

In some embodiments, a shape of a top of at least one of the first surfaces may be substantially different from a shape of at least one other first surface. In other embodiments, the shape of the top of each of the first surfaces may be substantially the same as the shapes of the tops of each of the other first surfaces. In some embodiments, the shape of the top of each of the first surfaces may be a regular polygon, or an irregular polygon. In some embodiments, each of the first surfaces includes a plurality of sidewalls, where each of the sidewalls is substantially vertical (e.g., may have a maximum angle from vertical of less than or equal to about 10 degrees).

In some embodiments, at least a portion of the first surfaces may have at least four second surfaces disposed on, and contained within a perimeter of, the top surface of the first surfaces. In some embodiments, a shape of a top of at least one of the second surfaces may be substantially different from a shape of at least one other second surface. In other embodiments, the shape of the top of each of the second surfaces may be substantially the same as the shapes of the tops of each of the other second surfaces. In some embodiments, the shape of the top of each of the first surfaces may be a regular polygon, or an irregular polygon.

In some embodiments, at least one of the substantially planar first surfaces of the optically diffusive film may have a surface texture (i.e., a surface texture that is different from any second surfaces the first surface have have). In some embodiments, the surface texture may have a average amplitude, A, and the substantially planar first surface may have a maximum lateral dimension, B, such that the ratio B/A is greater than about 10, or greater than about 15, or greater than about 20, or greater than 50, or greater than 100. In some embodiments, A may be less than about 50%, or less than about 40%, or less than about 30%, or less than about 20% of Hmin. In some embodiments, the surface texture may have a random pattern. In some embodiments, the surface texture may have a pseudo-random pattern. In some embodiments, the surface texture may have a regular pattern.

In some embodiments, at least one of the substantially planar first surfaces of the optically diffusive film may have both a surface texture and a plurality of second structures disposed on, and within a perimeter of, the substantially planar first surface. In some embodiments, the surface texture may be disposed on both the first surface and any second structures disposed on the first surface. In such embodiments, the average amplitude, A, of the surface texture may be less than about 50%, or less than about 30%, or less than about 10%, of a height of the second structures.

It should be noted that, for the purposes of this specification, the average amplitude, A, shall be considered to be equivalent to two times Sa, or 2(Sa), where Sa is the arithmetical mean height of the surface texture as defined in the ISO Standard 25178, an international standard relating to the analysis of 3D areal surface textures.

In some embodiments of the optically diffusive film, for a substantially collimated incident light which is normally incident to a plane of the first major surface, for at least a first wavelength in a human-visible (visible) wavelength range extending from about 400 nm to about 700 nm, or from about 420 nm to about 650 nm, the optically diffusive film may have an optical haze, Hv, and an optical clarity, Cv, and for at least a second wavelength in an infrared wavelength range extending from about 700 nm to about 2000 nm, or about 800 nm to about 1500 nm, the optically diffusive film has an optical haze, Hi, and an optical clarity, Ci, such that the ratio Hv/Hi is greater than or equal to about 1.2, or greater than or equal to about 1.5, or greater than or equal to about 2.0, or greater than or equal to about 5, or greater than or equal to about 10, and the ration Ci/Cv is greater than or equal to about 1.2, or greater than or equal to about 1.5, or greater than or equal to about 2.0, or greater than or equal to about 5, or greater than or equal to about 10. Optical haze and optical clarity shall be as defined elsewhere herein.

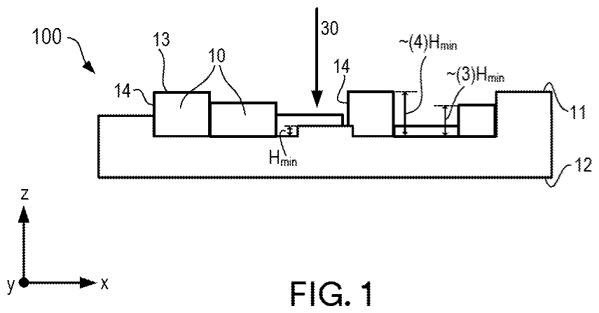

Turning now to the figures, FIG. 1 is a side view of one embodiment of an optically diffusive film 100 with a plurality of first structures (first surfaces 10). In some embodiments, optically diffusive film has a first (top) major surface 11 and an opposing second (bottom) major surface 12. In some embodiments, the first major surface 11 is a structured surface, including a plurality of substantially parallel, substantially planar first surfaces 10. Stated another way, first surfaces 10 include a top surface 13 which is substantially planar, and each of the top surfaces 113 of first surfaces 10 are substantially parallel to each other. In some embodiments, each of the first surfaces 10 may have one or more sidewalls 14 which are substantially vertical or which have a steep slope. In some embodiments, for example, the maximum angle of any sidewall 14 may be less than or equal to about 10 degrees, or about 5 degrees, from vertical. In some embodiments, second major surface 12 may be substantially planar. In other embodiments, as discussed elsewhere herein, second major surface 12 may include a plurality of second structures.

In some embodiments, the plurality of first surfaces are disposed at a plurality of discrete height levels (i.e., distance of the first surfaces above the first major surface in the Z direction, as shown in FIG. 1). Hmin is defined to be a height difference between a lowest first surface and the next-lowest first surface, as shown in FIG. 1. In some embodiments, the plurality of discrete height levels may be such that each height level (each difference between a selected first surface 10 and any other first surface 10) is S times Hmin, where S is an integer value, or within about 10%, or about 15%, or about 20% of an integer value. For example, as shown in FIG. 1, the height of one first surface 10 is about 3 times the Hmin value, and the height of a second first surface 10 is about 4 times Hmin.

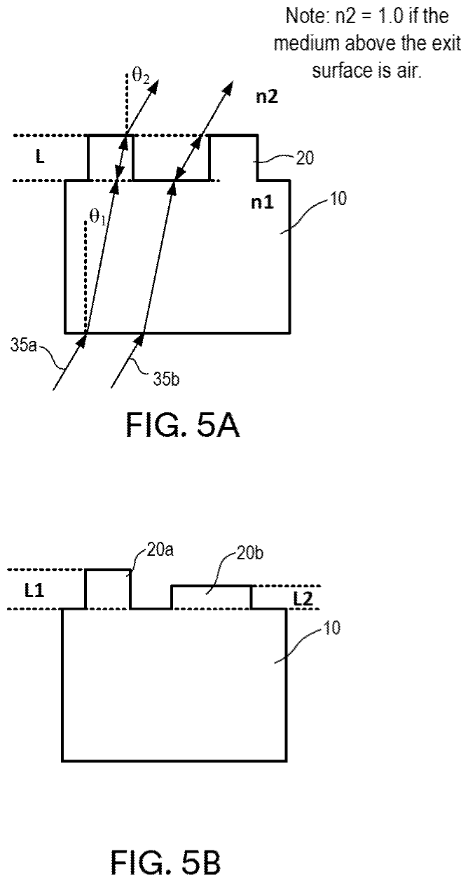

In some embodiments, for substantially collimated light 30 normally incident on a plane of the first major surface, the optically diffusive film may be configured such that an optical haze for one or more visible wavelengths is greater than an optical haze for one or more infrared wavelengths, and an optical clarity for one or more visible wavelengths is less than an optical clarity for one or more infrared wavelengths. Stated another way, the heights selected for the substantially planar first surfaces may be such that the optically diffusive film exhibits high zeroth order diffraction efficiencies for the at least one infrared wavelength. In some embodiments, the plurality of discrete height levels shall result in a phase difference between light transmitted through the optically diffusive film and light transmitted through air that is about a multiple of 2π. See, for example, FIG. 5B, discussed elsewhere herein.

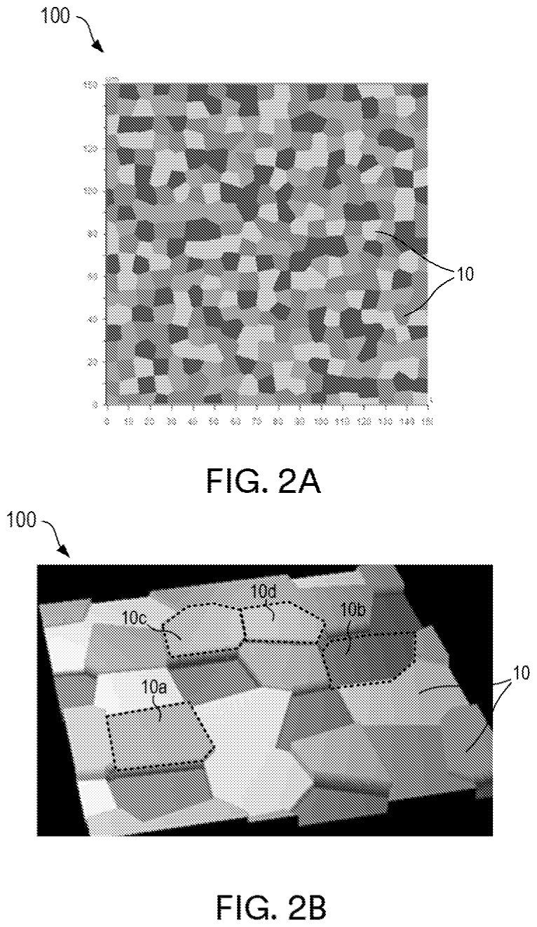

FIGS. 2A and 2B depict computer models of an embodiment of the optically diffusive film of FIG. 1. FIG. 2A is a top view of the computer model, showing a plurality of first surfaces 10 which substantially cover optically diffusive film 100. In the embodiment of FIG. 2A, each of the first surfaces 10 has the shape of a different irregular polygon, and each of the shades of grey used represents a different one of a plurality of discrete height levels. FIG. 2B provides a perspective, close-up view of a portion of the first major surface of optically diffusive film 100, detailing the three-dimensional aspects of first surfaces 10. Three separate first surfaces 10 are indicated, 10a, and 10c, demonstrating the possible differences in size, shape, and height. Each of the shapes of 10a, 10b, and 10c are irregular polygons with different shapes, and each has a different height level, indicated by the shade of grey used (as well as can be visually seen in FIG. 2B). It should be noted that adjacent surfaces may be disposed at the same height level, giving the appearance of a single surface. For example, first surface 10c is adjacent to, and at the same height level, as first surface 10d, making them appear to be one longer surface.

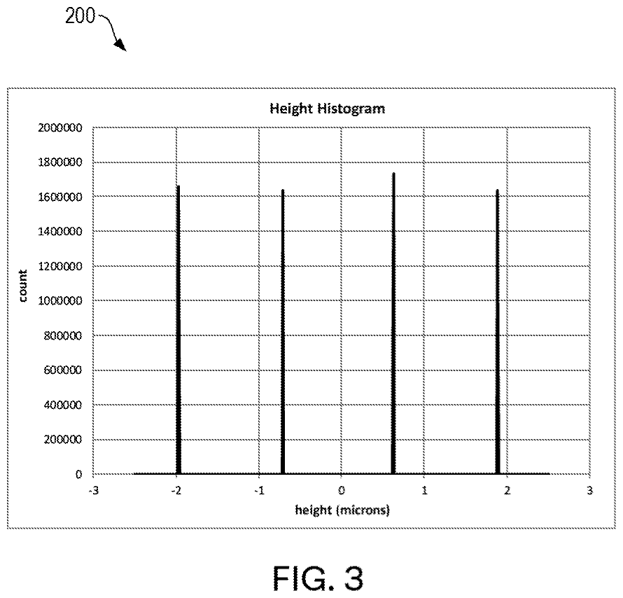

FIG. 3 is a histogram 200 of the various height levels of the example optically diffusive film of FIGS. 2A and 2B. In this example, there are four height levels indicated, represented by the four peaks (spikes) shown in the plot line. The x-axis (bottom axis) of the plot is height of the features in microns, relative to a plane defined for the film from which height increase or decrease (are positive or negative heights). In some embodiments, the distribution of the height levels is substantially equal. For example, with four discrete height levels, the distribution of each of the height levels may be approximately 25%, although each of the distribution percentages may vary from the equal distribution model by some amount, based on the algorithms and processes used to select the height levels, as well as the sample size of the film.

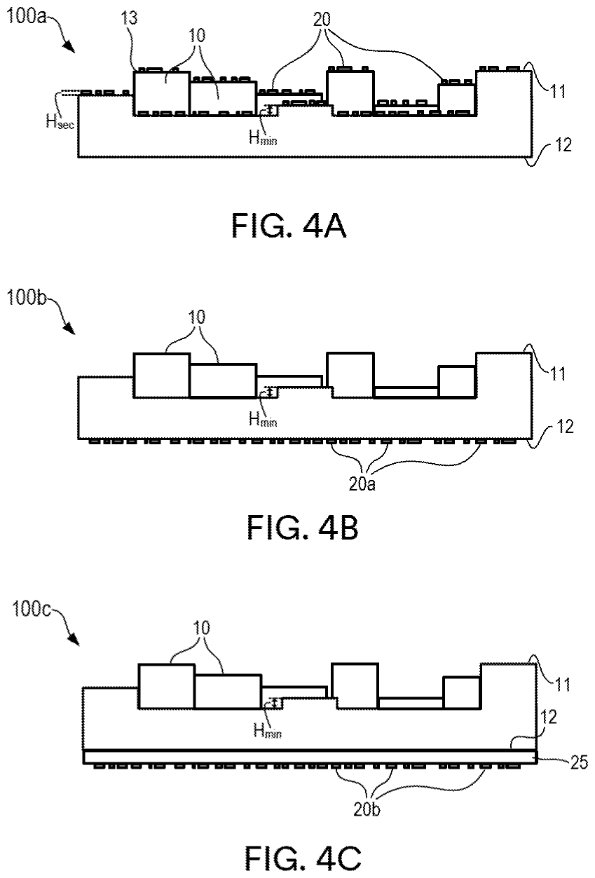

FIGS. 4A-4C provide views of an optically diffusive film with a plurality of first structures and a plurality of smaller second structures, in accordance with an embodiment of the present description. In the embodiment of the optically diffusive film 100a shown in FIG. 4A, a plurality of substantially parallel, substantially planar second structures 20 (alternatively referred to as “second surfaces”) are superimposed on a top surface 13 of the plurality of first surfaces 10. These second structures 20 may, for example, add additional amounts of haze (e.g., diffusion) in the visible wavelengths for the optically diffusive film. These second structures 20 may be configured such that an average height, Hsec, is a percentage of the Hmin value of the first surfaces. In some embodiments, for example, Hsec may be about 20%, about 30%, or about 40% of the value of Hmin. In the alternate embodiment of the optically diffusive film 100b of FIG. 4B, the plurality of second structures 20a may be disposed on the second major surface 12 of the optically diffusive film 100b, rather than on the plurality of first surfaces 10. In the alternate embodiment of the optically diffusive film 100c of FIG. 4C, the plurality of second structures 20b may be disposed on a separate optical layer 25, which is disposed adjacent to, and substantially coextensive with, second major surface 12 of optically diffusive film 100c.

FIGS. 5A and 5B show additional detail regarding the relationship between the first surfaces 10 and second structures 20 of FIG. 4A. FIG. 5A shows that the height, L, of the second structures 20 may be chosen such that the phase difference between a light ray 35a which passes through one of the second structures 20 versus a light ray 35b which passes through one of the first surfaces 10 but does not pass through one of the second structures 20 meets the specified requirement for optical performance. As the light ray 35a first enters first surface 10, it is refracted by an angle, θ1, and as it exits the top of second structure 20, it is refracted by an angle, θ2. The phase difference between rays 35a and 35b can then be calculated by the formula:

phase difference=2πL(n1 cos(θ1)−n2 cos(θ2))/λ,

where n1 is the refractive index of the material of first surface 10 and second structure 20, n2 is the refractive index of the material the light ray enters after exiting first surface 10 or second structure 20, and λ is the wavelength of light, and:

n1 sin(θ1)=n2 sin(θ2)

In the embodiment of FIG. 5A, each of the plurality of second structures 20 has substantially the same height, L. In some embodiments, such as the embodiment of FIG. 5B, at least some of the second structures 20 may be different in height. For example, second structure 20a has height L1, and structure 20b has height L2. It should be noted that, in the case that the medium above the exit surface is air, then n2=1.0 (the refractive index of air), and the equation can be simplified accordingly.

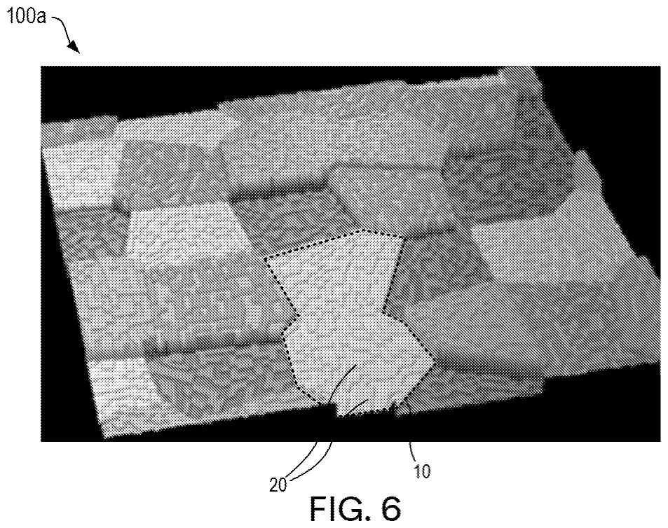

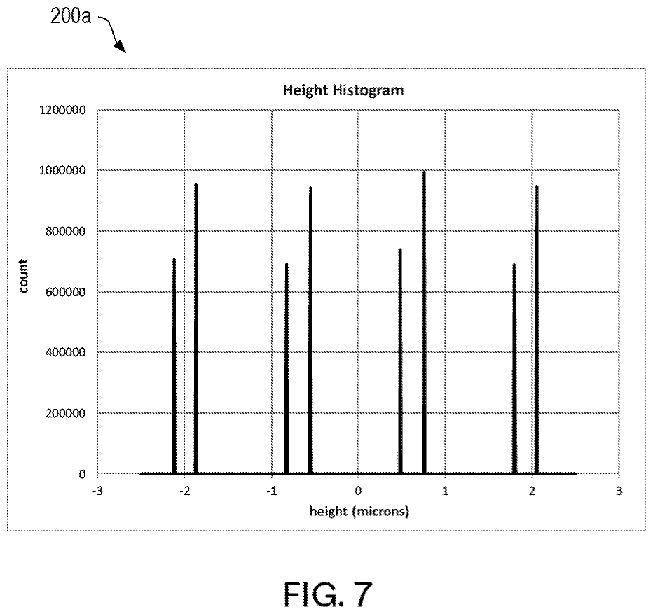

FIG. 6 depicts a computer model of the embodiment of optically diffusive film 100a of FIG. 4A. As shown in FIG. 6, a plurality of secondary structures 20 are disposed across a top surface of each of the plurality of first surfaces 10. FIG. 7 is a histogram 200a of the various height levels of the optically diffusive film 100a of FIG. 4A. As shown in FIG. 7, superimposing the second structures 20 on top of the first surfaces 10 (as shown in FIG. 4A) adds a second height level to each of the four discrete height levels that were already present for the first surfaces 10 (i.e., assuming all of the second structures 20 are substantially the same height). Comparing the histogram of FIG. 7 to that of FIG. 3, it can be seen that there are now two peaks for each of the four peaks of FIG. 3, as the second structures 20 add a new second height level that is close to each of the previous peaks.

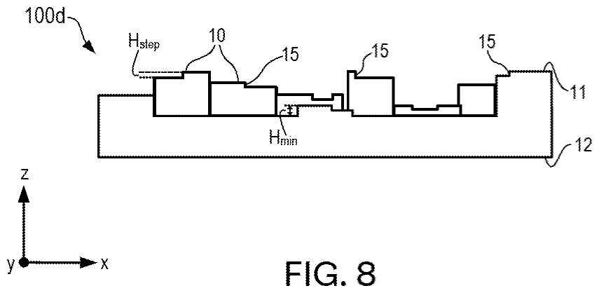

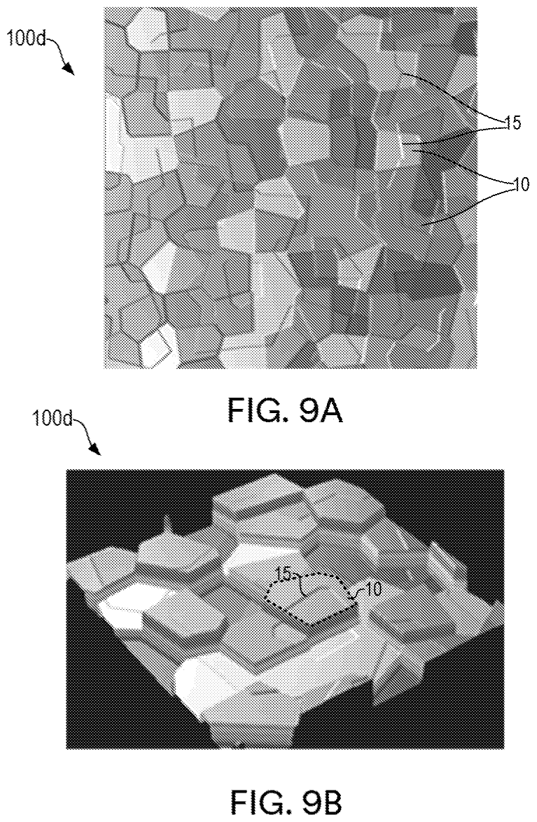

FIG. 8 is a side view of an alternate embodiment of an optically diffusive film 100d with a plurality of first structures. In this embodiment, a second mechanism is used to provide additional height levels to the optically diffusive film 100d. In the embodiment of FIG. 8, each of the first surfaces 10 has one or more height steps 15 dividing the top surfaces into two or more regions of different height. A height of the height step 15, Hstep, may be smaller than, and a fraction of, the minimum height difference Hmin. In some embodiments, for example, Hstep may be about 20%, or about 30%, or about 40% of Hmin. FIGS. 9A and 9B depict computer models of the embodiment of the optically diffusive film 100d of FIG. 8. FIG. 9A shows a top view of optically diffusive film 100d with a plurality of first surfaces 10 and height step differences 15. FIG. 9B shows a perspective view of a portion of an optically diffusive film 100d providing additional details on first structures 10 and height steps 15. The height step differences 15 may be made by any appropriate process, including through the introduction of second structures 20 as discussed elsewhere herein. In some embodiments, the process used to create the outline pattern of first surfaces 10 (to configure the pattern of irregular polygons, for example) may be applied a second time, creating a second outline pattern of irregular polygons, which can then be superimposed on top of the first outline pattern in a non-registered fashion (i.e., the two sets of outline patterns are not aligned) as a step height difference. This may result in at least a portion of the first surfaces 10 having one or more height steps 15.

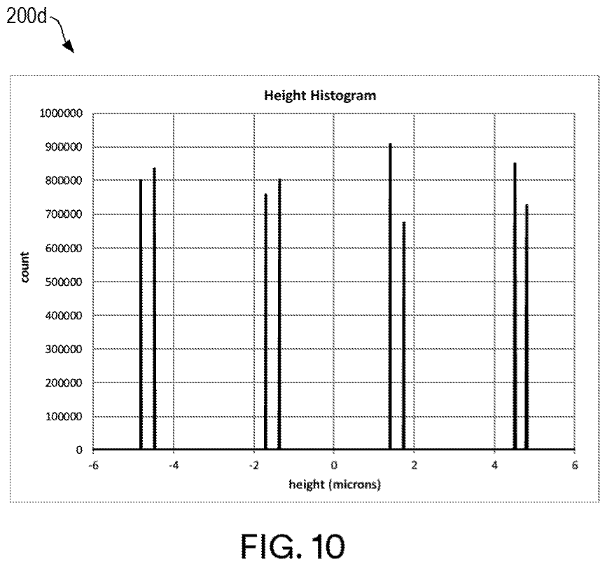

FIG. 10 is a histogram 200d of the various height levels of the optically diffusive film 100d of FIG. 8. Similar to the use of second structures 20 as detailed in the discussion of FIGS. 4-7, histogram 200d of FIG. 10 shows eight discrete height levels, dispersed in pairs of distribution peaks. The introduction of height steps 15 (as seen in FIGS. 8-9) changes the number of discrete height levels from 4 (without height steps 15) to 8, assuming the height of each of the height steps is substantially the same across optically diffusive film 100d.

It should be noted that, although the number of height steps shown in the examples is 4 (for histogram 200, FIG. 3) or 8 (for histograms 200b and 200d, FIGS. 7 and 10, respectively), any appropriate number of height steps may be used, including, but not limited to, 3, 4, 6, 8, 10, or 15. The number of discrete height levels can be configured based on the specific optical requirements of the specific application.

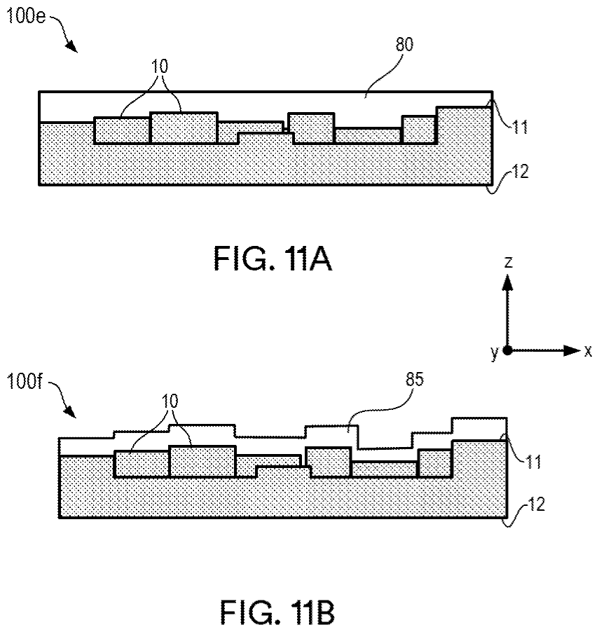

FIGS. 11A and 11B provide views of alternate embodiments of optically diffusive films 100e and 100f, which feature a plurality of first structures embedded in a top optical layer. In the embodiment of FIG. 11A, optically diffusive film 100e includes a planarization layer 80 which is disposed over first surfaces 10, such that first surfaces 10 are embedded within planarization layer and a substantially planar top layer is provided for optically diffusive film 100e. The material selected for the planarization layer 80 may be an optically transparent material (e.g., a polymer material) that has a refractive index that is different from the refractive index that is different from the material used for optically diffusive film 100e. For example, the planarization layer 80 may have a refractive index that is similar to the refractive index of air, so that the intended refraction location (i.e., the interface between first surfaces 10 and the material of planarization layer 80 is embedded, rather than in open air.

In the embodiment of optically diffusive film 100f of FIG. 11B, a conformal coat layer 85 is used to embed first surfaces 10. Conformal coat layer 85 may substantially conform to the shape of first surfaces 10 but may otherwise function in a manner similar to planarization layer 80, as described above.

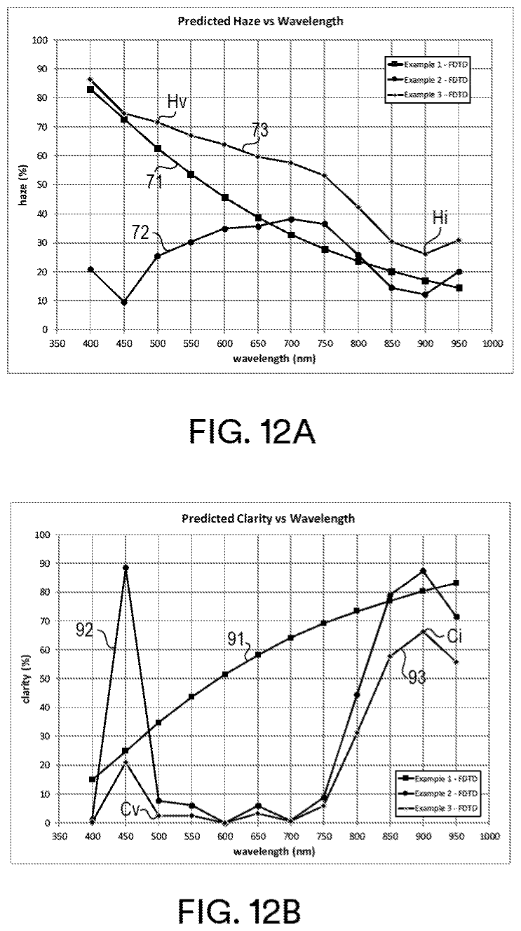

FIGS. 12A and 12B provide plots of optical haze versus wavelength and optical clarity versus wavelength, respectively, for an optically diffusive film, such as film 100 of FIG. 1. The optical haze and optical clarity values shown were calculated from the bi-directional transmittance distribution functions (BTDF) predicted from computer generated height maps using finite difference time domain modeling (FDTD). FIG. 12A provides plots of haze values versus wavelength for three example optically diffusive films as described herein. Plot 71 is a comparative example (Example 1) wherein the film features only the smaller second structures 20 (as shown, for example, in FIG. 4A) without any first surfaces 10. That is, plot 71 shows the haze percentages versus wavelength for an optical film with only one height level of small surface structures, and shows a predictable drop in haze from shorter, visible wavelengths toward longer, infrared wavelengths. Plot 72 (Example 2) shows the haze percentages versus wavelength for an optical film with only first surfaces 10 (assuming four discrete height levels) and no second structures 20. The plot for Example 2 (Plot 72) shows a relatively low haze value in the infrared (for example, around 900 nm), but also has a low haze value in the visible wavelength range (for example, around 450 nm). This dip in haze in the visible range can occur at harmonics of the wavelength in the infrared range for which the first structures 10 have been configured to provide a low haze value. For example, selecting the discrete height levels such that they provide a low haze value at 900 nm can cause a similar dip in haze at a harmonic of 900 nm, for example, 450 nm. While Plot 72 (Example 2) may work well in some applications requiring low haze in the infrared, some applications may require more optical haze across the visible spectrum. In these cases, Plot 73 (Example 3), for a film with both first surfaces 10 (at four discrete height levels) and second structures 20 (at one height level) superimposed on top of the first surfaces 10, has a relatively high haze value, Hv, in the visible range (for example, at visible wavelength 500 nm) and a relatively low haze value, Hi, in the infrared range (for example, at near infrared wavelength 900 nm). The addition of the smaller, second structures 20 on the first surfaces 10 increases the haze (e.g., diffusion) in the visible to create Plot 73. The value of Hv is greater than Hi, and may, in some embodiments, be greater than 1.2, or 1.5, or 2.0, or 5, or 10 times the value of Hi.

FIG. 12B provides plots of optical clarity values versus wavelength for three example optically diffusive films as described herein. Plot 91 is a comparative example (Example 1) wherein the film features only the smaller second structures 20 (as shown, for example, in FIG. 4A) without any first surfaces 10. That is, plot 91 shows the clarity percentages versus wavelength for an optical film with only one height level of small surface structures and shows a predictable increase in optical clarity from shorter, visible wavelengths toward longer, infrared wavelengths. Plot 92 (Example 2) shows the optical clarity percentages versus wavelength for an optical film with only first surfaces 10 (assuming four discrete height levels) and no second structures 20. The plot for Example 2 (Plot 92) shows a relatively high clarity value in the infrared (for example, around 900 nm), but also has a peak clarity value in the visible wavelength range (for example, around 450 nm). This second peak in clarity in the visible range can occur at harmonics of the wavelength in the infrared range for which the first structures 10 have been configured to provide a high clarity value. For example, selecting the discrete height levels such that they provide a high clarity value at 900 nm can cause a similar spike in clarity at a harmonic of 900 nm, for example, 450 nm. While Plot 92 (Example 2) may work well in some applications requiring high clarity in the infrared, some applications may require less optical clarity (more optical diffusion) across the visible spectrum. In these cases, Plot 73 (Example 3), for a film with both first surfaces 10 (at four discrete height levels) and second structures 20 (at one height level) superimposed on top of the first surfaces 10, has a relatively low clarity value, Cv, in the visible range (for example, at visible wavelength 500 nm) and a relatively high clarity value, Ci, in the infrared range (for example, at near infrared wavelength 900 nm). This dip in haze in the visible range can occur at harmonics of the wavelength in the infrared range for which the first structures 10 have been configured to provide a low haze value. For example, selecting the discrete height levels such that they provide a low haze value at 900 nm can cause a similar dip in haze at a harmonic of 900 nm, for example, 450 nm. The addition of the smaller, second structures 20 on the first surfaces 10 decreases the clarity (e.g., adds more diffusion) in the visible to create Plot 93. While Plot 93 shows a small peak in clarity at 450 nm, it is significantly reduced over the corresponding peak in Plot 92 at 450 nm. The value of Ci is greater than Cv, and may, in some embodiments, be greater than 1.2, or 1.5, or 2.0, or 5, or 10 times the value of Hi.

That is, an embodiment of an optically diffusive film as described herein may exhibit a haze that is significantly higher in the visible wavelengths than in the infrared wavelengths, and a clarity that is significantly higher in the infrared wavelengths than in the visible wavelengths. Factors such as the number of discrete height levels and use of second structures 20 can be used to tailor an optical film to meet the specific optical requirements of an application.

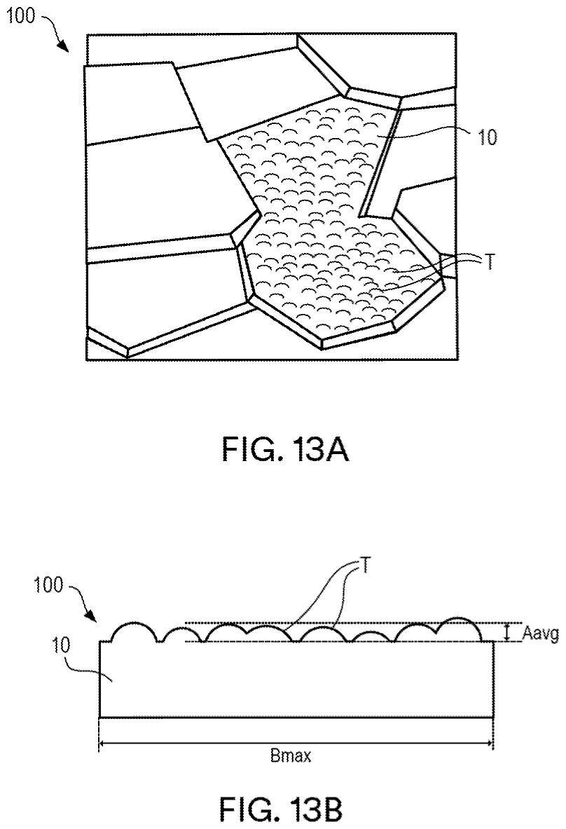

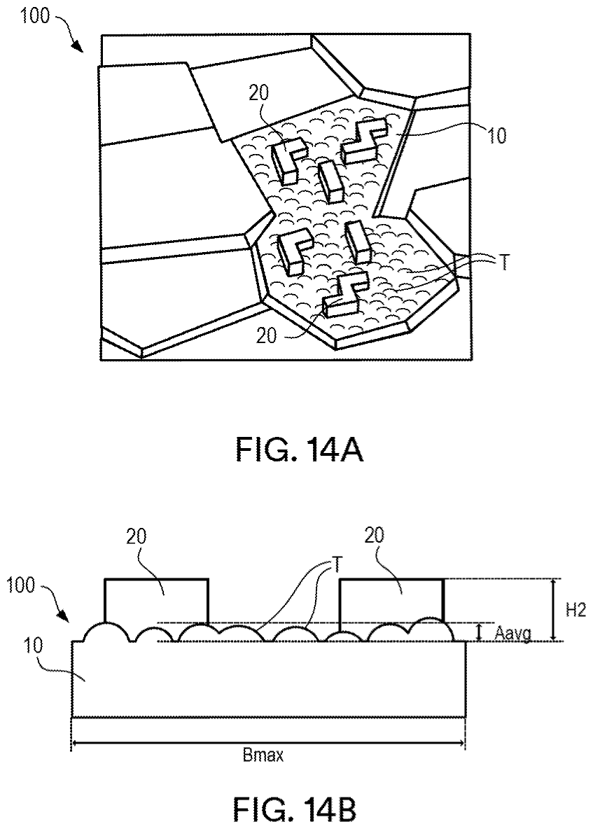

FIGS. 13A and 13B illustrate an optically diffusive film 100 with a plurality of first surfaces 10d which feature a surface texture T. In some embodiments, surface texture T may be applied through any appropriate process, including, but not limited to, deposition, chemical etching, a mechanical process, or a separate film with diffusive features or embedded diffusive particles. Surface texture T may have a random pattern, a pseudo-random pattern, or a regular pattern. It should be noted that surface texture T is not the same as second structures 20, such as those shown in FIGS. 4A-4C, and, in some embodiments (not shown), first surfaces 10d may have both surface texture T and second structures 20 present (see FIGS. 14A and 14B). In some embodiments, the average amplitude of the features of surface texture T (Aavg, FIG. 13B) may be less than the corresponding heights of second structures 20. Also, the value of Aavg may be less than a maximum lateral dimension Bmax of any of the first surfaces 10, such that the ratio Bmax/Aavg is greater than about 10, or greater than about 15, or greater than about 20, or greater than about 50, or greater than about 100. In some embodiments, A may be less than about 50%, or less than about 40%, or less than about 30%, or less than about 20% of Hmin.

FIGS. 14A and 14B illustrate an optically diffusive film 100 with a plurality of first structures 10 featuring a surface texture T as well as a plurality of second structures 20. In some embodiments, the average amplitude, A, of the surface texture may be less than about 50%, or less than about 30%, or less than about 10%, of a height, H2, of the second structures.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optically diffusive film comprising a structured first major surface comprising a plurality of substantially parallel substantially planar first surfaces arranged across the first major surface at a plurality of different first height levels along a thickness direction of the optically diffusive film, a height difference between any two of the first surfaces being S times Hmin, S a number within 15% of an integer and Hmin a height difference between lowest and next-lowest first surfaces;
wherein, for a substantially collimated incident light substantially normally incident on a plane of the first major surface:
for at least a first wavelength in a visible wavelength range extending from about 400 nm to about 700 nm, the optically diffusive film has an optical haze Hv and an optical clarity Cv; and
for at least a second wavelength in an infrared wavelength range extending from about 700 nm to about 2000 nm, the optically diffusive film has an optical haze Hi and an optical clarity Ci, Hv/Hi≥1.5 and Ci/Cv≥1.5.

2. The optically diffusive film of claim 1, wherein a full divergence angle of the substantially collimated incident light is less than about 2 degrees.

3. The optically diffusive film of claim 1, wherein a full divergence angle of the incident light is substantially less than a full divergence angle of the transmitted diffuse light.

4. The optically diffusive film of claim 1, wherein a percentage of an area of the structured first major surface covered by the substantially planar first surfaces is at least 80%.

5. The optically diffusive film of claim 1, wherein at least a portion of the substantially planar first surfaces has at least one height step.

6. The optically diffusive film of claim 1, further comprising a planarizing layer disposed on the structured first major surface, wherein at least a portion of the plurality of substantially parallel substantially planar first surfaces are embedded within the planarizing layer.

7. The optically diffusive film of claim 1, further comprising a conformal coating layer disposed on the structured first major surface, wherein at least a portion of the plurality of substantially parallel substantially planar first surfaces are embedded within the conformal coating layer.

8. The optically diffusive film of claim 1, further comprising a plurality of secondary structures, smaller than, and superimposed on, the substantially planar first surfaces.

9. The optically diffusive film of claim 8, wherein a height of each of the secondary structures is substantially similar to a height of each of the other secondary structures.

10. The optically diffusive film of claim 8, wherein a height of at least one of the secondary structures is different from a height of at least one other secondary structure.

11. The optically diffusive film of claim 1, wherein at least one of the substantially planar first surfaces comprises a surface texture having an average amplitude A, wherein A is less than about 50%, or optionally less than about 40%, or optionally less than about 30%, or optionally less than about 20% of Hmin.

12. The optically diffusive film of claim 1, further comprising a plurality of secondary structures disposed on a second major surface of the optically diffusive film, the second major surface opposing the structured first major surface.

13. The optically diffusive film of claim 1, further comprising a separate optical layer disposed adjacent to and substantially coextensive with the optically diffusive film and comprising a plurality of secondary structures disposed on the second optical layer.

14. The optically diffusive film of claim 1, wherein each of the substantially planar first surfaces comprises a plurality of sidewalls, and each of the plurality of sidewalls is substantially vertical.

15. The optically diffusive film of claim 1, further comprising a second major surface opposing the structured first major surface, the second major surface of the optically diffusive film being substantially planar.

16. The optically diffusive film of claim 1, wherein the substantially planar first surfaces are arranged at four discrete height levels.

17. The optically diffusive film of claim 1, wherein a height distribution of each of the plurality of discrete height levels is (100/N) %, where N is a number of discrete height levels.

18. The optically diffusive film of claim 1, further comprising a resin, the resin having a refractive index of about 1.66 for light with a wavelength of 940 nanometers.

19. The optically diffusive film of claim 1, wherein the plurality of discrete height levels is chosen such that the optically diffusive film exhibits high zeroth order diffraction efficiencies for the at least one wavelength in the second wavelength range.

20. The optically diffusive film of claim 19, wherein, for the at least one wavelength in the second wavelength range, the plurality of discrete height levels results in a phase difference between light transmitted through the optically diffusive film and light transmitted through air that is about a multiple of 2π.
